(19) United States
(12) Patent Application Publication
(10) Pub. No.: US 2025/0054970 A1
(43) Pub. Date: Feb. 13, 2025

(54) CATHODE ACTIVE MATERIALS AND POWDERS

(71) Applicant: Apple Inc., Cupertino, CA (US)

(72) Inventors: Huiming Wu, San Jose, CA (US); Martin Bettge, San Jose, CA (US); Shawn W. Snyder, Santa Clara, CA (US)

(21) Appl. No.: 18/799,809

(22) Filed: Aug. 9, 2024

Related U.S. Application Data
(60) Provisional application No. 63/519,186, filed on Aug. 11, 2023.

(51) Int. Cl. H01M 4/525; H01M 4/02

(52) U.S. Cl. CPC H01M 4/525; H01M 2004/021; H01M 2004/028

(57) ABSTRACT

The disclosure is directed to sintered cathode active materials than can be used in lithium-ion batteries. The sintered cathode active materials are prepared by forming a calcinated powder. The calcinated power is combined with inactive components to form a slurry. The slurry is dried and densified to form a green body. The green body is sintered to form the sintered cathode active material. The powder, slurry, green body, and sintered cathode active material have properties that provide improved performance of the cathode active material.

### PRIORITY

This patent application claims the benefit of U.S. Provisional Patent Application No. 63/519,186, entitled “Sintered Cathode Active Materials,” filed on Aug. 11, 2023, which is incorporated herein by reference in its entirety.

### FIELD

This disclosure relates generally to batteries, and more particularly, to cathode active materials for lithium-ion batteries.

### BACKGROUND

A commonly used type of rechargeable battery is a lithium battery, such as a lithium-ion or lithium-polymer battery. As battery-powered devices become increasingly small and more powerful, batteries powering these devices need to store more energy in a smaller volume. Lithium transition metal oxides can be used in cathode active materials for lithium-ion batteries. These compounds can include lithium cobalt oxide or derivatives thereof.

### SUMMARY

In a first aspect, the disclosure is directed to a powder including a compound selected from Formula (I).

Formula (I) has the chemical structure

Liₐ(CoₓNi_{y}Mn_{z})_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Ca, Ti, Mg, and a combination thereof;
(x+y+z) is (1−b);
0.95≤a≤1.05;
0<b≤0.50; and
1.95≤c≤2.05.

In some variations, Me is selected from Na, Si, S, Al, K, V, Cr, Fe, Cu, Zn, Mn, Ni, Zr, Y, Mo, Sn, Ag, Nb, Ca, Ti, Mg, and a combination thereof. In some variations, Me is selected from Si, S, Al, K, V, Cr, Fe, Cu, Zn, Mn, Ni, Zr, Y, Mo, Sn, Ag, Nb, Ca, Ti, Mg, and a combination thereof.

In some variations, the amount of Na is less than or equal to 500 ppm. In some variations, the amount of Na is less than or equal to 400 ppm. In some variations, the amount of Na is less than or equal to 300 ppm. In some variations, the amount of Na is less than or equal to 200 ppm. In some variations, the amount of Na is less than or equal to 100 ppm.

In some variations, x is (1−b), y is 0, and z is 0.

In some variations, y is (1−b), z is 0, and z is 0.

In some variations, z is (1−b), x is 0, and y is 0.

In some variations, the compound has the structure of Formula (I), wherein Me is a single element, and 0<b≤0.15.

In some variations, the compound has the structure of Formula (I), wherein Me is more than one element and each separate element is present in an amount less than or equal to 0.10.

In some variations, the compound has the structure of Formula (I), wherein Me is selected from Ni, Mn, and Al; Al, Ti, and Mg; La, Zr, and Ni; La, Zr, Ni, and Al; La and Al; Ca and Ti; Ca, Ti, and Al; Ca and Mg; and Ca, Mg, and Al.

Various combinations of Formula (I) described herein can be combined in any combination.

In some variations, powder has a D50 less than or equal to 0.30 μm and a D90 is less than or equal to 0.5 μm.

In some variations, the powder has a zeta-potential of less than or equal to −40 mV.

In some variations, the average powder particle is non-spherical and comprises one or more facets.

In a second aspect, the disclosure is directed to a slurry combining the powder and comprising the powder and a binder.

In some variations, the powder is polyvinyl butyral (PVB).

In some variations, the slurry has a pre-compaction density of 1.10-1.50 g/cc. In further variations, the slurry has a pre-compaction viscosity of at least 800 cps.

In a third aspect, the disclosure is directed to a green body including the compacted slurry. In some variations, the green body packing density is 3.1-3.3 g/cc. In some variations, the average green body thickness can be 33-37 μm.

In a fourth aspect, the disclosure is directed to a sintered cathode active material. The sintered cathode active material can include a compound of Formula (I). Formula (I) has the chemical structure

Liₐ(CoₓNi_{y}Mn_{z})_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Ca, Ti, Mg, and a combination thereof;
(x+y+z) is (1−b);
0.96≤a≤1.05;
0<b≤0.50; and
1.96≤c≤2.05.

In some variations, Me is selected from Na, Si, S, Al, K, V, Cr, Fe, Cu, Zn, Mn, Ni, Zr, Y, Mo, Sn, Ag, Nb, Ca, Ti, Mg, and a combination thereof. In some variations, Me is selected from Si, S, Al, K, V, Cr, Fe, Cu, Zn, Mn, Ni, Zr, Y, Mo, Sn, Ag, Nb, Ca, Ti, Mg, and a combination thereof.

In some variations, the amount of Na is less than or equal to 500 ppm. In some variations, the amount of Na is less than or equal to 400 ppm. In some variations, the amount of Na is less than or equal to 300 ppm. In some variations, the amount of Na is less than or equal to 200 ppm. In some variations, the amount of Na is less than or equal to 100 ppm.

In some variations, x is (1−b), y is 0, and z is 0.

In some variations, y is (1−b), z is 0, and z is 0.

In some variations, z is (1−b), x is 0, and y is 0.

In some variations, the sintered cathode active material has a grain and grain boundary density of at least 95 volume % of the total sintered cathode active material. In some variations, the sintered cathode active material has less than 5 wt % of inactive components. In some variations, the sintered cathode active material has less than 5 vol % of inactive components. In some variations, in the sintered cathode active material the grain d50≤1.5 μm and grain d90≤2.5 μm.

In some variations, the average thickness is from 25 μm to 35 μm. In some variations, the average grain boundary in the sintered cathode active material is less than 10 nm. In some variations, the average lithium-ion diffusing crystal plane is parallel to the electrolyte/cathode interface.

In a fifth aspect, the disclosure is directed to a method of making a sintered cathode. A powder is as described herein is formed. The powder is combined with a binder to form a slurry. The slurry is compacted to form a green body. The green body is sintered at a temperature of 700° C.-1100° C. to form a sintered cathode active material.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell in accordance with an illustrative embodiment;

FIG. 2 is a side view of a set of layers for a battery cell in accordance with an illustrative embodiment;

FIG. 3 is a flow chart depicting the preparation of the sintered cathode active material, in accordance with an illustrative embodiment;

FIG. 4 depicts modeled volumetric capacity as a function of cathode thickness, in accordance with illustrative embodiments;

FIG. 5A depicts cathode active materials with different elemental compositions that result in reduced phase transitions and increased performance of the batteries describe herein, in accordance with illustrative embodiments;

FIG. 5B depicts LCO cathode active materials having 0.4 at % Mn/0.4 at % Ni, in accordance with illustrative embodiments; and

FIG. 6 depicts the average C-lattice parameter and the average A-lattice parameter as a function of LCO capacity, in accordance with illustrative embodiments.

### DETAILED DESCRIPTION

The following description is presented to allow any person skilled in the art to make and use the embodiments, and is provided in the context of a particular application. Various modifications to the disclosed embodiments will be readily apparent to those skilled in the art, and the general principles defined herein may be applied to other embodiments and applications without departing from the spirit and scope of the present disclosure. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Thus, the disclosure is not limited to the embodiments shown, but is to be accorded the widest scope consistent with the principles and features disclosed herein.

As used herein, all compositions referenced for cathode active materials represent those of as-prepared materials (i.e., “virgin” materials) unless otherwise indicated. Materials of these compositions have not yet been exposed to additional processes, such as de-lithiation and lithiation during, respectively, charging and discharging of a lithium-ion battery.

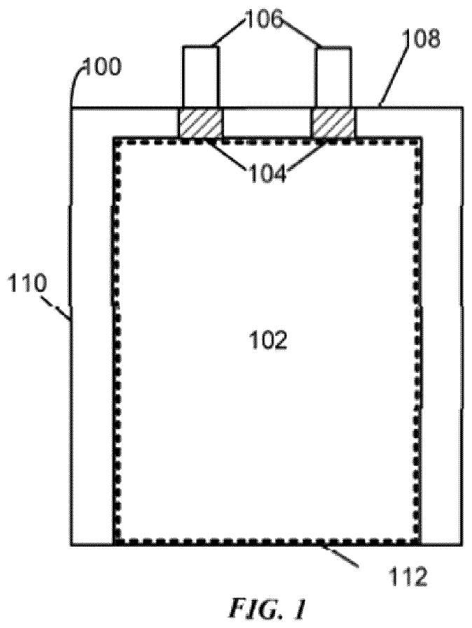

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode, a separator, and an anode. The stack 102 also includes a separator disposed between the cathode and anode. The cathode, anode, and separator layers may be left flat in a planar configuration.

Battery cells can be enclosed, for example in a flexible pouch or a hard case. Returning to FIG. 1, during assembly of the battery cell 100, the stack 102 can be enclosed in a pouch. The pouch can be flexible or rigid. The stack 102 may be in a planar configuration, although other configurations are possible. If flexible, the pouch can be formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a terrace seal 108. In some variations, the flexible pouch may be less than 120 microns thick to improve the packaging efficiency of the battery cell 100, the density of battery cell 100, or both.

The stack 102 also includes a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack.

Batteries can be combined in a battery pack in any configuration. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

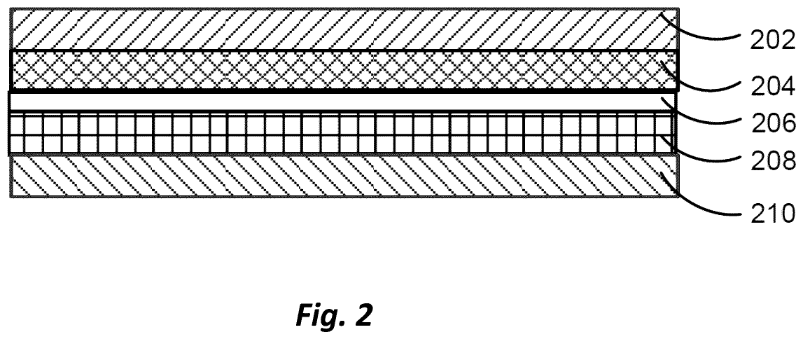

FIG. 2 presents a side view of a set of layers for a first battery cell (e.g., the battery cell 100 of FIG. 1) in accordance with the disclosed embodiments. The set of layers may include a cathode current collector 202, a cathode active material 204, a separator 206, an anode active material 208, and an anode current collector 210. The cathode current collector 202 and the cathode active material 204 form a cathode for the battery cell, and the anode current collector 210 and the anode active material 208 form an anode for the battery cell. To create the battery cell, the set of layers may be stacked in a planar configuration.

As mentioned above, the cathode current collector 202 may be aluminum foil, the cathode active material 204 may be a lithium compound, the anode current collector 210 may be copper foil, the anode active material 208 may be carbon, and the separator 206 may include a conducting polymer electrolyte.

It will be understood that the cathode active materials described herein can be used in conjunction with any battery cells or components thereof known in the art. For example, the layers may be stacked and/or used to form other types of battery cell structures, such as bi-cell structures. All such battery cell structures are known in the art.

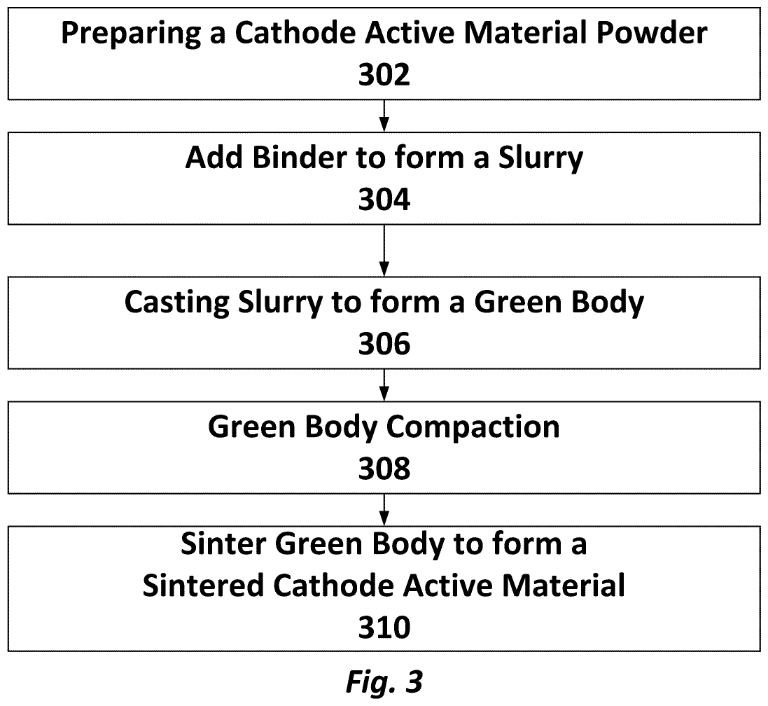

The disclosure is directed to sintered cathode active materials than can be used in lithium-ion batteries. With respect to FIG. 3, the cathode active material is prepared in the form of a calcinated powder 302. The powder can have a uniform D50 and D90, among other properties. The calcinated power is combined with inactive components to form a slurry 304. The slurry is then dried and densified to form a green body 306 (e.g., tape casting). The green body is then compacted 308. The compacted green body is sintered to form a sintered cathode active material 310.

The sintered cathode active material can be highly pure (e.g., low quantities of non-cathode active materials). The sintered cathode further can have a grain orientation parallel to the cathode active material surface that can limit lithium-ion diffusion perpendicular to the cathode active material surface while limiting cathode expansion parallel to the cathode active material surface. The powder, slurry, green body, and sintered cathode active material have properties that provide improved performance of the cathode active material.

### Powders

The sintered cathode active materials are formed from a calcinated powder. The powder includes individual particles.

In some variations, the powder includes a compound represented by Formula (I):

Liₐ(CoₓNi_{y}Mn_{z})_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Ca, Ti, Mg, and a combination thereof;
(x+y+z) is (1−b);
0.95≤a≤1.05;
0<b≤0.50; and
1.95≤c≤2.05.

In some variations, x is (1−b). In some variations, y is (1−b). In some variations, z is (1−b). In some variations, the compound has the structure of Formula (I), wherein Me is a single element, and 0<b≤0.15.

In some variations, x is at least 0.5. In some variations, x is at least 1.0. In some variations, x is at least 1.5. In some variations, x is at least 2.0. In some variations, x is at least 2.5. In some variations, x is at least 3.0. In some variations, x is at least 3.5. In some variations, x is at least 4.0. In some variations, x is at least 4.5. In some variations, x is at least 5.0. In some variations, x is at least 5.5. In some variations, x is at least 6.0. In some variations, x is at least 6.5. In some variations, x is at least 7.0. In some variations, x is at least 7.5. In some variations, x is at least 8.0. In some variations, x is at least 8.5. In some variations, x is at least 9.0. In some variations, x is at least 9.5. In some variations, x is at least 10.0.

In some variations, y is at least 0.5. In some variations, y is at least 1.0. In some variations, y is at least 1.5. In some variations, y is at least 2.0. In some variations, y is at least 2.5. In some variations, y is at least 3.0. In some variations, y is at least 3.5. In some variations, y is at least 4.0. In some variations, y is at least 4.5. In some variations, y is at least 5.0. In some variations, y is at least 5.5. In some variations, y is at least 6.0. In some variations, y is at least 6.5. In some variations, y is at least 7.0. In some variations, y is at least 7.5. In some variations, y is at least 8.0. In some variations, y is at least 8.5. In some variations, y is at least 9.0. In some variations, y is at least 9.5. In some variations, y is at least 10.0.

As described in variations herein, x and y can be combined in any combination. In some variations, x and y are the same.

In some variations, where Me is a single element selected from Na, Si, S, Al, K, V, Cr, Fe, Cu, Zn, Mn, Ni, Zr, La, Ce, Y, Mo, Sn, Ag, Nb, Ca, Ti, and Mg, then 0<b≤0.15.

In further variations, Me is more than one element and each separate element present in b is less than or equal to 0.10.

In still further variations, Me is selected from Al, Mn, Ni, Zr, La, Ce, Y, Mo, Sn, Ag, Nb, Ca, Ti, and Mg.

In some variations, Me is Ni and b is less than or equal to 0.50. In some variations, Me is Ni and b is less than or equal to 0.40. In some variations, Me is Ni and b is less than or equal to 0.30. In some variations, Me is Ni and b is less than or equal to 0.20. In some variations, Me is Ni and b is less than or equal to 0.10. In some variations, Me is Ni and b is less than or equal to 0.05.

In some variations, Me is a combination of Ni, Mn, and Al. In some variations, Me is a combination of Ni and Al. In some variations, Me is a combination of Al, Ti, and Mg. In some variations, Me is a combination of La, Zr, and Ni. In some variations, Me is a combination of La, Zr, Ni, and Al. In some variations, Me is a combination of La and Al. In some variations, Me is a combination of Ca and Ti. In some variations, Me is a combination of Ca, Ti, and Al. In some variations, Me is a combination of Ca and Mg. In some variations, Me is a combination of Ca, Mg, and Al.

The amounts of any element or elements of Me, or selected groups of Me, can be combined with the amount of each element or elements in any combination described herein.

In some variations, Me is selected from Na, Si, S, Al, K, V, Cr, Fe, Cu, Zn, Mn, Ni, Zr, Y, Mo, Sn, Ag, Nb, Ca, Ti, Mg, and a combination thereof. In some variations, Me is selected from Si, S, Al, K, V, Cr, Fe, Cu, Zn, Mn, Ni, Zr, Y, Mo, Sn, Ag, Nb, Ca, Ti, Mg, and a combination thereof.

In some variations, the amount of Na is less than or equal to 500 ppm. In some variations, the amount of Na is less than or equal to 400 ppm. In some variations, the amount of Na is less than or equal to 300 ppm. In some variations, the amount of Na is less than or equal to 200 ppm. In some variations, the amount of Na is less than or equal to 100 ppm.

In some variations, the compound can be any compound described in PCT US2017/052436 or PCT/US2017/022320, both of which are incorporated herein by reference in their entirety.

In various aspects, the calcinated powder is formed of particles with a D50 and/or D90 as described below. In various aspects, the D50 and D90 are measured by scanning electron microscopy (SEM). In some variations, the powder particle D50 is less than or equal to 0.30 μm. In some further variations, D90 is less than or equal to 0.5 μm.

In some variations, the powders have a D50 less than or equal to 0.25 μm. In some variations, the particles have a D50 less than or equal to 0.20 μm. In some variations, the particles have a D50 less than or equal to 0.15 μm. In some variations, the particles have a D50 of at least 0.10 μm. In some variations, the particles have a D50 of at least 0.15 μm. In some variations, the particles have a D50 of at least 0.20 μm. In some variations, the particles have a D50 of at least 0.25 μm. As referred to herein, the D50 can have an upper limit, lower limit, or both upper and lower limit in any combination described herein.

In some variations, the particles have a D90 less than 0.50 μm. In some variations, the particles have a D90 of less than or equal to 0.40 μm. the particles have a D90 of at least 0.40 μm. In some variations, the particles have a D90 less than or equal to 0.30 μm. In some variations, the particles have a D90 less than or equal to 0.25 μm. In some variations, the particles have a D90 less than or equal to 0.20 μm. In some variations, the particles have a D90 less than or equal to 0.15 μm. In some variations, the particles have a D90 less than or equal to 0.10 μm. In some variations, the particles have a D90 less than or equal to 0.05 μm.

In some variations, the particles have a D90 of at least 0.03 μm. In some variations, the particles have a D90 of at least 0.05 μm. In some variations, the particles have a D90 of at least 0.07 μm. In some variations, the particles have a D90 of at least 0.10 μm. In some variations, the particles have a D90 of at least 0.15 μm. In some variations, the particles have a D90 of at least 0.20 μm. In some variations, the particles have a D90 of at least 0.25 μm. In some variations, the particles have a D90 of at least 0.30 μm. the particles have a D90 of at least 0.40 μm.

As referred to herein, the D90 can have an upper limit, lower limit, or both upper and lower limit in any combination described herein.

### Slurry

The calcinated powder is combined with a binder and optionally other non-cathode active materials to form a slurry.

Binders can be any binder suitable for cathode active materials known in the art. Examples of binders include polyvinyl butyral (PVB) or styrene-butadiene rubber (SBR). In some particular variations, the binder is PVB.

Before compaction of the slurry, the slurry can have a density of 1.10-1.50 g/cc. In some variations, the pre-compaction slurry density is at least 1.10 g/cc. In some variations, the pre-compaction slurry density is at least 1.15 g/cc. In some variations, the pre-compaction slurry density is at least 1.20 g/cc. In some variations, the pre-compaction slurry density is at least 1.25 g/cc. In some variations, the pre-compaction slurry density is at least 1.30 g/cc. In some variations, the pre-compaction slurry density is at least 1.35 g/cc.

In some variations, the pre-compaction slurry density is less than or equal to 1.40 g/cc. In some variations, the pre-compaction slurry density is less than or equal to 1.35 g/cc. In some variations, the pre-compaction slurry density is less than or equal to 1.30 g/cc. In some variations, the pre-compaction slurry density is less than or equal to 1.25 g/cc. In some variations, the pre-compaction slurry density is less than or equal to 1.20 g/cc. In some variations, the pre-compaction slurry density is less than or equal to 1.15 g/cc.

As referred to herein, the slurry density can have an upper limit, lower limit, or both upper and lower limit in any combination described herein.

In some variations, the pre-compaction viscosity of the slurry is at least 800 cps. In some variations, the pre-compaction viscosity of the slurry is at least 850 cps. In some variations, the pre-compaction viscosity of the slurry is at least 900 cps. In some variations, the pre-compaction viscosity of the slurry is at least 950 cps. In some variations, the pre-compaction viscosity of the slurry is at least 1000 cps.

The particle size distributions (D50 and D90) in the slurry are as described herein.

As referred to herein, the pre-compaction viscosity can have an upper limit, lower limit, or both upper and lower limit in any combination described herein.

### Green Body

The green body packing density can be 3.1-3.3 g/cc. In some variations, the green body packing density is at least 3.0 g/cc. In some variations, the green body packing density is at least 3.1 g/cc. In some variations, the green body packing density is at least 3.2 g/cc. In some variations, the green body packing density is at least 3.3 g/cc. In some variations, the green body packing density is less than or equal to 3.4 g/cc. In some variations, the green body packing density is less than or equal to 3.3 g/cc. In some variations, the green body packing density is less than or equal to 3.2 g/cc. In some variations, the green body packing density is less than or equal to 3.1 g/cc. As referred to herein, the green body packing density can have an upper limit, lower limit, or both upper and lower limit in any combination described herein.

In some variations, the average green body thickness can be 33-37 μm. In some variations, the average green body thickness is at least 34 μm. In some variations, the average green body thickness is at least 35 μm. In some variations, the average green body thickness is at least 36 μm. In some variations, the average green body thickness is at least 37 μm. In some variations, the average green body thickness is less than or equal to 38 μm. In some variations, the average green body thickness is less than or equal to 37 μm. In some variations, the average green body thickness is less than or equal to 36 μm. In some variations, the average green body thickness is less than or equal to 35 μm. In some variations, the average green body thickness is less than or equal to 34 μm. As described herein, the average green body thickness can have an upper limit, lower limit, or both upper and lower limit in any combination described herein.

After milling, the powder has a zeta-potential of less than or equal to −40 mV. In some variations, the post-milling zeta-potential of the powder is less than or equal to −50 mV. In some variations, the post-milling zeta-potential of the powder is less than or equal to −60 mV. In some variations, the post-milling zeta-potential of the powder is less than or equal to −70 mV. In some variations, the post-milling zeta-potential of the powder is less than or equal to −80 mV.

Post-compaction, the green body is formed of a powder having particles with a D50 and D90 as described herein for calcinated powder.

### Sintered Cathode Active Materials

The green body can be sintered at high temperature to form a sintered cathode. The sintering temperatures are greater than 700° C., or 700° C.-1100° C. The binder added to the green body is volatilized and thereby reduced or removed from the sintered cathode. Following air-annealing, the sintered cathode can have various properties including thickness, density, low pore porosity. The sintered cathode can have small, oriented grains. In certain variations, the grains are elongated spherical, and/or in some cases have one or more facets that can result in grain alignment and orientation.

The sintered cathode active material provides improvements over un-sintered cathode active materials. In various aspects, the sintered cathode active materials have a low amount (e.g., less than 5 wt % and/or 5% volume) of inactive components. The sintered cathode active materials can improve lithium-ion diffusion within the cathode active material, while limiting liquid electrolyte penetration. The sintered cathode active materials also can reduce volume change during charge and discharge due to the absence of inactive components. As a result, the sintered cathode active material can have an improved specific capacity and chemical stability at high voltages. Further, the sintered cathode active material can reduce the impact of phase transitions during battery charge and discharge. The net cost of sintered cathode active material can be reduced as compared to conventional cathode active material.

Further, the sintered cathode active material has a specific grain orientation. The sintered cathode active material grains align to orient with lithium-ion diffusing crystal planes parallel to electrolyte/cathode interface. Without wishing to be limited to a particular mechanism or mode of operation, the orientation can limit lithium-ion diffusion perpendicular to the cathode active material surface while limiting cathode expansion parallel to the cathode active material surface.

The particles can include one or more facets. When prepared, the particles undergo a calcining process. Milling the agglomerated structure creates facets in the non-spherical particles. Preparing the particles at a higher temperature results in a larger number of facets on particles. Each grain can have one or more facets. The greater number of facets, in general the greater orientation of the cathode active material grains. Creating a high shear condition under the casting head creates orientation, which can shape the angle within the cathode structure. The grain orientation of the eventual sintered cathode active material can be influenced by the calcining temperature of the powder particles. Further, creating grains that have a homogenous grain size and range, e.g. D50, and D90 described herein, allows grains to be mobile along boundaries.

In some variations, the grains in the sintered cathode active material grains are small, oriented grains having a D50 of 200 nm-5000 nm. The ranges of the D50 of the sintered grains have can have a minimum value, maximum value, or both. In some variations, the sintered cathode active material grains have a D50 of at least 200 nm. In some variations, the sintered cathode active material grains have a D50 of at least 500 nm. In some variations, the sintered cathode active material grains have a D50 of at least 1000 nm. In some variations, the sintered cathode active material grains have a D50 of at least 1500 nm. In some variations, the sintered cathode active material grains have a D50 of at least 2000 nm. In some variations, the sintered cathode active material grains have a D50 of at least 2500 nm. In some variations, the sintered cathode active material grains have a D50 of at least 3000 nm. In some variations, the sintered cathode active material grains have a D50 of at least 3500 nm. In some variations, the sintered cathode active material grains have a D50 of at least 4000 nm. In some variations, the sintered cathode active material grains have a D50 of at least 4500 nm. In some variations, the sintered cathode active material grains have a D50 of less than or equal to 5000 nm. In some variations, the sintered cathode active material grains have a D50 of less than or equal to 4500 nm. In some variations, the sintered cathode active material grains have a D50 of less than or equal to 4000 nm. In some variations, the sintered cathode active material grains have a D50 of less than or equal to 3500 nm. In some variations, the sintered cathode active material grains have a D50 of less than or equal to 3000 nm. In some variations, the sintered cathode active material grains have a D50 of less than or equal to 2500 nm. In some variations, the sintered cathode active material grains have a D50 of less than or equal to 2000 nm. In some variations, the sintered cathode active material grains have a D50 of less than or equal to 1500 nm. In some variations, the sintered cathode active material grains have a D50 of less than or equal to 1000 nm. In some variations, the sintered cathode active material grains have a D50 of less than or equal to 500 nm.

As described herein, the D50 can have an upper limit, lower limit, or both upper and lower limit in any combination described herein.

The sintered cathode active in some instances can be thin, but is not limited to a particular thickness and can perform over a range of thicknesses. In variations in which the sintered cathode active material is thin (e.g., has an average thickness of less than or equal to 10 μm), the sintered cathode active material can provide a high volumetric and gravimetric capacity. In variations where the cathode active material is thicker (e.g., has an average thickness greater than or equal to 10 μm).

In some variations, the average thickness of the sintered cathode active material is from 1 μm to 250 μm. In some more specific variations, the average thickness of the sintered cathode active material is from 20 μm to 50 μm. In some more specific variations, the average thickness of the sintered cathode active material is from 25 μm to 35 μm. In some variations, the average thickness of the sintered cathode active material is less than or equal to 30 μm in thickness. In some variations, the average thickness of the sintered cathode active material is less than or equal to 20 μm in thickness. In some variations, the average thickness of the sintered cathode active material is less than or equal to 15 μm in thickness. In some variations, the average thickness of the sintered cathode active material is less than or equal to 10 μm in thickness. In some variations, the average thickness of the sintered cathode active material is less than or equal to 5 μm in thickness.

In some variations, the average grain boundary in the sintered cathode active material is less than 10 nm. In some variations, the average grain boundary in the sintered cathode active material is less than 8 nm. In some variations, the average grain boundary in the sintered cathode active material is less than 6 nm. In some variations, the average grain boundary in the sintered cathode active material is less than 4 nm. In some variations, the average grain boundary in the sintered cathode active material is less than 2 nm. In some variations, the average cross-sectional area between three or more grains of the sintered cathode active material grains can extend up to half the d50 grain size.

In some variations, the average thickness of the sintered cathode active material is at least 1 μm. In some variations, the average thickness of the sintered cathode active material is at least 10 μm. In some variations, the average thickness of the sintered cathode active material is at least 20 μm. In some variations, the average thickness of the sintered cathode active material is at least 25 μm. In some variations, the average thickness of the sintered cathode active material is at least 30 μm. In some variations, the average thickness of the sintered cathode active material is at least 35 μm. In some variations, the average thickness of the sintered cathode active material is at least 40 μm. In some variations, the average thickness of the sintered cathode active material is at least 50 μm. In some variations, the average thickness of the sintered cathode active material is at least 1 μm. In some variations, the average thickness of the sintered cathode active material is at least 75 μm. In some variations, the average thickness of the sintered cathode active material is at least 100 μm. In some variations, the average thickness of the sintered cathode active material is at least 125 μm. In some variations, the average thickness of the sintered cathode active material is at least 150 μm. In some variations, the average thickness of the sintered cathode active material is at least 175 μm. In some variations, the average thickness of the sintered cathode active material is at least 200 μm. In some variations, the average thickness of the sintered cathode active material is at least 225 μm.

In some variations, the average thickness of the sintered cathode active material is less than or equal to 250 μm. In some variations, the average thickness of the sintered cathode active material is less than or equal to 225 μm. In some variations, the average thickness of the sintered cathode active material is less than or equal to 200 μm. In some variations, the average thickness of the sintered cathode active material is less than or equal to 175 μm. In some variations, the average thickness of the sintered cathode active material is less than or equal to 150 μm. In some variations, the average thickness of the sintered cathode active material is less than or equal to 125 μm. In some variations, the average thickness of the sintered cathode active material is less than or equal to 100 μm. In some variations, the average thickness of the sintered cathode active material is less than or equal to 75 μm. In some variations, the average thickness of the sintered cathode active material is less than or equal to 50 μm. In some variations, the average thickness of the sintered cathode active material is less than or equal to 45 μm. In some variations, the average thickness of the sintered cathode active material is less than or equal to 40 μm. In some variations, the average thickness of the sintered cathode active material is less than or equal to 35 μm. In some variations, the average thickness of the sintered cathode active material is less than or equal to 30 μm. In some variations, the average thickness of the sintered cathode active material is less than or equal to 25 μm. In some variations, the average thickness of the sintered cathode active material is less than or equal to 20 μm. In some variations, the average thickness of the sintered cathode active material is less than or equal to 15 μm. In some variations, the average thickness of the sintered cathode active material is less than or equal to 10 μm.

As described herein, the average thickness of the sintered cathode active material can have an upper limit, lower limit, or both upper and lower limit in any combination described herein.

In various aspects, the sintered cathode active material has high density and a small quantity of inactive components. This can result in reduced pore porosity, thereby allowing very little liquid electrolyte penetration.

In some variations, sintered cathode active material grains comprise at least 95 vol % of the total cathode active material. In some variations, sintered cathode active material grains comprise at least 96 vol % of the total cathode active material. In some variations, sintered cathode active material grains comprise at least 97 vol % of the total cathode active material. In some variations, sintered cathode active material grains comprise at least 98 vol % of the total cathode active material. In some variations, sintered cathode active material grains comprise at least 99 vol % of the total cathode active material. In some variations, sintered cathode active material grains comprise at least 99.5 vol % of the total cathode active material. In some variations, sintered cathode active material grains comprise 99.9 vol % of the total cathode active material.

In some variations, sintered cathode active material grains comprise at least 95 wt % of the total cathode active material. In some variations, sintered cathode active material grains comprise at least 96 wt % of the total cathode active material. In some variations, sintered cathode active material grains comprise at least 97 wt % of the total cathode active material. In some variations, sintered cathode active material grains comprise at least 98 wt % of the total cathode active material. In some variations, sintered cathode active material grains comprise at least 99 wt % of the total cathode active material. In some variations, sintered cathode active material grains comprise at least 99.5 wt % of the total cathode active material. In some variations, sintered cathode active material grains comprise 99.9 wt % of the total cathode active material.

In some variations, the sintered cathode active material has inactive cathode material (e.g., non-cathode active, non-ion storing, non-ion conducting material) that is less than or equal to 5.0 vol % of the total cathode active material. In some variations, the sintered cathode active material has inactive cathode material that is less than or equal to 4.0 vol % of the total cathode active material. In some variations, the sintered cathode active material has inactive cathode material that is less than or equal to 3.0 vol % of the total cathode active material. In some variations, the sintered cathode active material has inactive cathode material that is less than or equal to 2.0 vol % of the total cathode active material. In some variations, the sintered cathode active material has inactive cathode material that is less than or equal to 1.0 vol % of the total cathode active material.

In some variations, the sintered cathode active material has inactive cathode material that is less than or equal to 5.0 wt % of the total cathode active material. In some variations, the sintered cathode active material has inactive cathode material that is less than or equal to 4.0 wt % of the total cathode active material. In some variations, the sintered cathode active material has inactive cathode material that is less than or equal to 3.0 wt % of the total cathode active material. In some variations, the sintered cathode active material has inactive cathode material that is less than or equal to 2.0 wt % of the total cathode active material. In some variations, the sintered cathode active material has inactive cathode material that is less than or equal to 1.0 wt % of the total cathode active material.

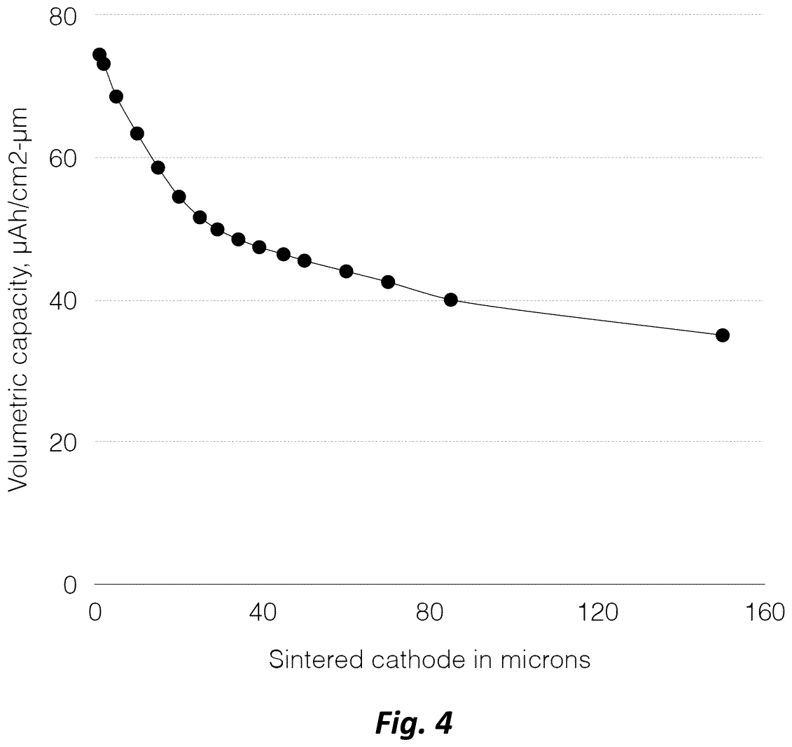

FIG. 4 depicts modeled volumetric capacity as a function of mean cathode thickness, according to illustrative embodiments. The sintered cathode includes a cathode active material including Li₂CoO₂ (LCO) without additional chemical modifications. The cathode with an average thickness of 30 microns+/−20 microns follows the curve of FIG. 4. At small thicknesses, the cathodes are energy dense with high volumetric capacities. At higher thicknesses, the volumetric capacity is maintained, showing a low slope as the cathode thickness increases from 40 microns to at least 160 microns. With higher cathode thicknesses, fewer layers are required in the battery stack. As a result, the battery is more effective. The sintered cathode provides for large range of thicknesses at high performance.

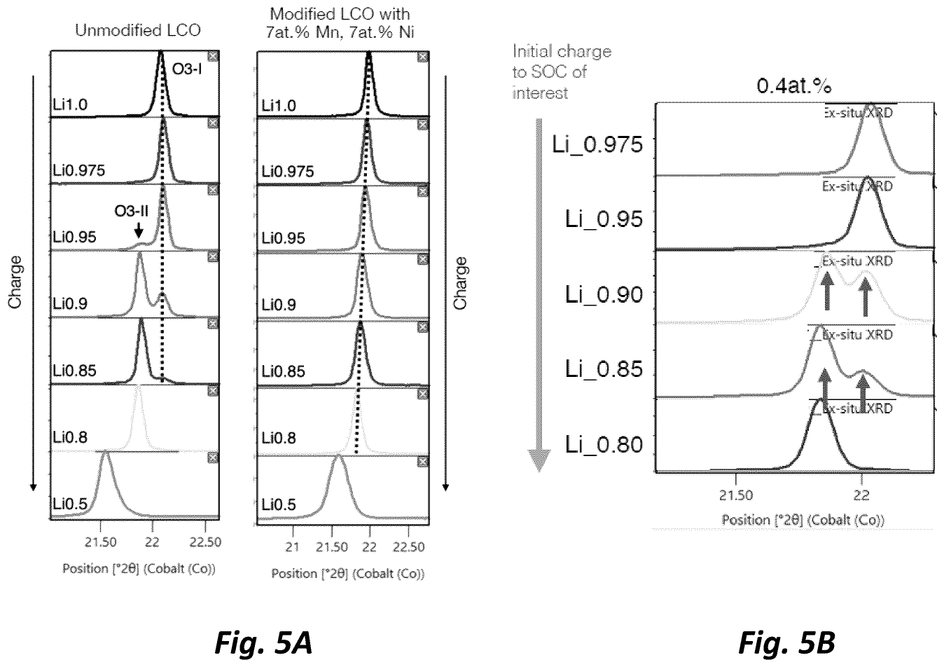

FIG. 5A depicts cathode active materials with different elemental compositions that result in reduced phase transitions and increased performance of the batteries describe herein. LCO cathode active materials having 0.4 at % Mn/0.4 at % Ni are depicted against cathode active materials having 7.0 at % Mn/7.0 at % Ni. Cathode active materials with 0.4 at % Mn and 0.4 at % Ni underwent a phase transition during Li diffusion, resulting in decreased battery performance. Cathode active materials with 7.0 at % Mn/7.0 at % Ni had no phase transition during Li diffusion. Cathode active materials with Mn and Ni of at least 0.4 at % Mn and 0.4 at % Ni. As described herein with respect to Formula (I), increased amounts of x and y can result in reduced likelihood of phase transitions and increased battery performance.

FIG. 5B depicts LCO cathode active materials having 0.4 at % Mn/0.4 at % Ni. Cathode active materials with 0.4 at % Mn and 0.4 at % Ni underwent a phase transition during Li diffusion, resulting in decreased battery performance. As described herein with respect to Formula (I), increased amounts of x and y can result in reduced likelihood of phase transitions and increased battery performance.

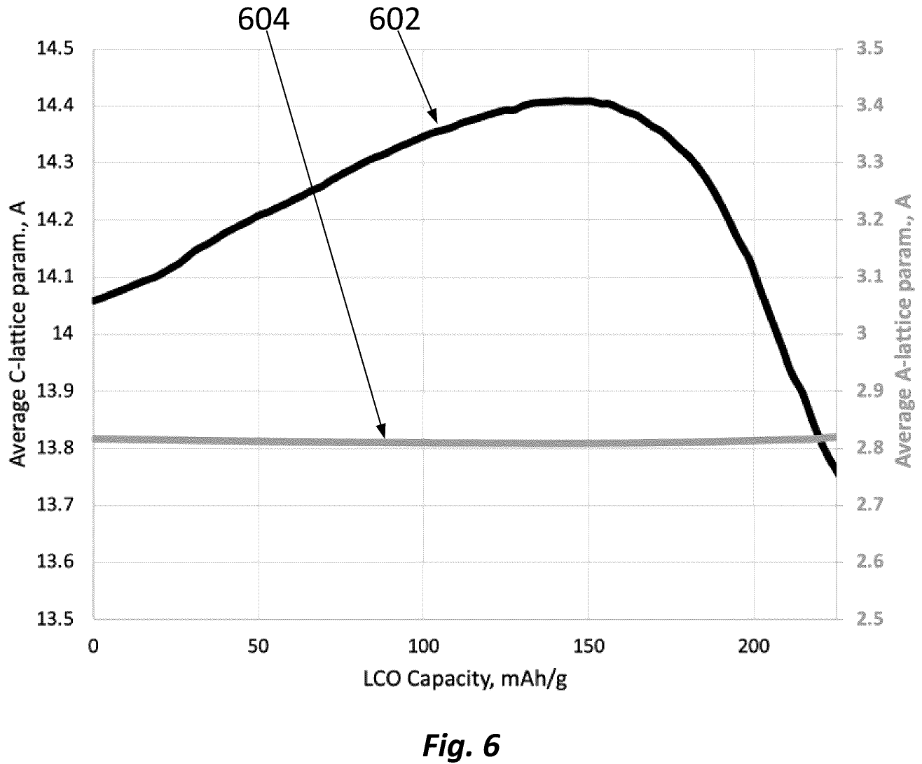

FIG. 6 depicts the average C-lattice parameter and the average A-lattice parameter as a function of LCO capacity. The upper curve corresponds to the change in volume of a conventional cell. Curve 602 shows the average A-lattice parameter in angstroms. Curve 604 shows the average C-lattice parameter in angstroms. As lithium is extracted from the cathode, the battery cell expands. The reason relates to grain orientation of the cathode active material. When the grains are oriented vertically, the battery expands and peak lithium diffusion. When grains are horizontally oriented, there is little expansion of the battery and also little lithium diffusion. The strain on a glass electrolyte caused by the disposed on the cathode active material can result in cracking of the material and an electrical short circuit.

For high diffusion and reduced lateral expansion, the orientation and diffusion can be balanced. The compositions, grains, methods, and sintered cathode active materials described herein show a balanced lateral expansion with high diffusivity.

The cathode active materials described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A powder comprising a compound selected from Formula (I):
Liₐ(CoₓNi_{y}Mn_{z})_{1-b}Me_{b}O_{c} (I)
wherein
Me is selected from Na, Si, S, Al, K, V, Cr, Fe, Cu, Zn, Mn, Ni, Zr, La, Ce, Y, Mo, Sn, Ag, Nb, Ca, Ti, Mg, and a combination thereof;
(x+y+z) is (1−b);
0.97≤a≤1.05;
0<b≤0.50; and
1.97≤c≤2.05.

2. The powder of claim 1, wherein 0<b≤0.15.

3. The powder of claim 2, wherein x is (1−b).

4. The powder of claim 2, wherein y is (1−b).

5. The powder of claim 1, wherein x is at least 0.5 and y is at least 0.5.

6. The powder of claim 1, wherein x is at least 6.0 and y is at least 6.0.

7. The powder of claim 1, wherein Me is selected from Na, Si, S, Al, K, V, Cr, Fe, Cu, Zn, Mn, Ni, Zr, Y, Mo, Sn, Ag, Nb, Ca, Ti, Mg, and a combination thereof.

8. The powder of claim 1, wherein Me comprises Na with a ppm less than or equal to 300 ppm.

9. The powder of claim 1, wherein Me is selected from Na, Si, S, Al, K, V, Cr, Fe, Cu, Zn, Mn, Ni, Zr, Y, Mo, Sn, Ag, Nb, Ca, Ti, Mg, and a combination thereof.

10. The powder of claim 1, wherein Me is a single element.

11. The powder of claim 1, wherein Me is more than one element and each separate element is present in an amount less than or equal to 0.10.

12. The powder of claim 1, wherein Me is selected from:
Ni, Mn, and Al;
Al, Ti, and Mg;
La, Zr, and Ni;
La, Zr, Ni, and Al;
La and Al;
Ca and Ti;
Ca, Ti, and Al;
Ca and Mg; and
Ca, Mg, and Al.

13. The power of claim 1, wherein the powder has a particle size D50 less than or equal to 0.30 μm.

14. The power of claim 1, wherein the powder has a particle size D50 less than or equal to 0.20 μm.

15. The power of claim 1, wherein the powder has a particle size D50 less than or equal to 0.15 μm.

16. The power of claim 1, wherein the powder has a particle size D50 at least 0.10 μm.

17. The power of claim 1, wherein the powder has a particle size D90 is less than or equal to 0.50 μm.

18. The power of claim 1, wherein the powder has a particle size D90 is less than or equal to 0.25 μm.

19. The powder of claim 1, having a zeta-potential of less than or equal to −40 mV.

20. The powder of claim 1, wherein an average particle is non-spherical and comprises one or more facets.
